(19) United States
(12) Patent Application Publication
(10) Pub. No.: US 2022/0344689 A1
(43) Pub. Date: Oct. 27, 2022

(54) Systems and Methods for Producing and Using Hydrogen from Natural Gas in Mobile Applications

(71) Applicant: Bionatus, LLC, Irvine, CA (US)

(72) Inventors: Peter Capuciati, Laguna Beach, CA (US); Matthew Case, Newport Beach, CA (US)

(21) Appl. No.: 17/727,633

(22) Filed: Apr. 22, 2022

Related U.S. Application Data
(60) Provisional application No. 63/178,462, filed on Apr. 22, 2021.
(60) Provisional application No. 63/178,470, filed on Apr. 22, 2021.
(60) Provisional application No. 63/178,474, filed on Apr. 22, 2021.

(51) Int. Cl. H01M 8/0612; B60L 50/75

(52) U.S. Cl. CPC H01M 8/0618; B60L 50/75; H01M 2250/20

(57) ABSTRACT

Applications of a natural gas reformer to mobile systems are described. A reformer with a plasma device is used to reform natural gas or light hydrocarbons to H2 and carbon. A vehicle includes the reformer, a natural gas reservoir, and a fuel cell. The fuel cell uses the H2 generated by the reformer to charge a battery in the vehicle or power an electric motor of the vehicle. Such systems are further used to distribute carbon, where carbon produced by the reformer is sorted to remove carbon black or nanostructure carbon, with each type of carbon compressed and or stored separately for use or commercialization. Such systems are further used to retrofit or otherwise reduce weight of electric vehicles (EV). Batteries installed in an EV are removed and replaced with a natural gas reservoir, reformer, and fuel cell, reducing the weight and improving efficiency of the EV.

This application claims the benefit of priority to U.S. Provisional Patent No. 63/178,462 filed Apr. 22, 2021, U.S. Provisional Patent No. 63/178,470 filed Apr. 22, 2021, and U.S. Provisional Patent No. 63/178,474 filed Apr. 22, 2021, each of which is incorporated by reference in its entirety herein.

### FIELD OF THE INVENTION

The field of the invention is clean energy technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Over the last couple of decades, the fight against climate change has gained significant urgency. This urgency has in turn inspired technical innovations that attempt to tackle the problem from different approaches.

One approach has been the development of electric vehicles. Electric vehicles have soared in popularity over the last decade, as battery technology has made viable designs possible. However, the technology still has significant hurdles to overcome before the internal combustion engine is rendered obsolete. On the production side, the materials required for battery production are very finite and may not support a truly global amount of vehicles. On the user side, charging times and range anxiety prevent electric vehicles from truly replacing traditional internal combustion engine-based vehicles.

Another approach has been the use of hydrogen as a fuel. Since the only byproduct of using hydrogen as a fuel is water, it is a very promising approach to environmentally-friendly energy. However, the production of hydrogen for use as fuel requires a great deal of energy. Moreover, hydrogen can be highly explosive, making the distribution of hydrogen a dangerous, costly process.

Hydrogen fuel cell vehicles have advantages over electric vehicles such as faster charging and a greatly-reduced battery size. Without the challenges associated with the generation and distribution of hydrogen, hydrogen fuel cell vehicles could surpass electric vehicles as a replacement for the traditional internal combustion engine.

Others have attempted to solve the challenge of generating hydrogen from natural gas. For example, the process for creating high-purity carbon black from natural gas by Monolith Materials, Inc. of Lincoln, Nebr. also results in hydrogen as a product. However, the facility required for this process is large and as such the problems associated with storage and distribution of hydrogen remain.

It is known to use a plasma reformer (plasmatron) to produce hydrocarbon-rich gas (50-75%) from natural gas (mostly methane), and then passing the hydrocarbon-rich gas to a fuel cell to produce electricity. See U.S. Pat. No. 5,409,784 (Bromberg, 1995), and L. Bromberg, D. R. Cohn and A. Rabinovich, “Plasma Reformer-Fuel Cell System For Decentralized Power Applications”, Int. J. Hydrogen Energy Vol 22., No. 1, pp 83094 (1997). Fuel cells combine the hydrogen-rich gas with oxygen from the air generate electricity and produce water. Suitable fuel cells are reported to include molten carbonate fuel cells (MCFC), solid oxide fuel cells (SOFC), and in phosphoric acid fuel cells (PAFC). This same prior art also teaches that the process can be utilized in a motor vehicle.

These and all other extrinsic materials are incorporated herein by reference in their entirety. Where a definition or use of a term in a reference that is incorporated by reference is inconsistent or contrary to the definition of that term provided herein, the definition of that term provided herein is deemed to be controlling.

Cross reference is made to U.S. Provisional Patent No. 63/178,449 filed Apr. 22, 2021, U.S. Provisional Patent No. 63/178,459 filed Apr. 22, 2021, U.S. Provisional Patent No. 63/178,464 filed Apr. 22, 2021, U.S. Provisional Patent No. 63/178,476 filed Apr. 22, 2021, U.S. Provisional Patent No. 63/178,478 filed Apr. 22, 2021, U.S. Provisional Patent No. 63/178,484 filed Apr. 22, 2021 and U.S. Provisional Patent No. 63/178,488 filed Apr. 22, 2021, each of which is copending and filed by Applicant.

One difficulty with most of Bromberg's devices and methods is that the hydrogen-rich gas comprises 25-75% H2 and 25-40% carbon monoxide (CO). The CO can be converted into carbon dioxide (C02) by injection of steam, which can interfere with operation of the fuel cells. Bromberg does teach an alternative embodiment, in which a plasmatron can be operated in a water-free, an oxygen deficient manner. In that embodiment, thermal decomposition eliminates production of both carbon monoxide (CO) and carbon dioxide (C02), and produces mostly pure hydrogen and carbon (soot). A remaining problem, however, is that at much reduced efficiencies (e.g., 30% for CH4) due to the high temperatures (1,000°-3,000° C.) required.

What is needed are systems and methods in which CH4, other light hydrocarbons, or mixtures such as natural gas, can be used to efficiently produce electricity in situ, without significant release carbonaceous gasses into the atmosphere.

### SUMMARY OF THE INVENTION

Systems, methods, and devices are disclosed for mobile applications of a natural gas reformer. Systems, methods, and devices for powering a vehicle from natural gas are contemplated. A feedstock of natural gas or other light hydrocarbons (or combinations thereof) is supplied to a reformer (e.g., having one or more plasma devices, etc.) within the vehicle. The reformer acts on the feedstock to produce hydrogen. A fuel cell coupled to the reformer generates electricity from the hydrogen, and the generated electricity powers an electric motor or device of the vehicle. Electricity can further be stored in a battery in the vehicle, whether excess or intended for storage (e.g., for use in surge demand or acceleration of vehicle). For example, stored electricity from the battery can be supplied to further power the electric motor in addition to electricity from the fuel cell.

The feedstock is stored in a reservoir within the vehicle, whether pressurized upon delivery to the vehicle or pressurized by the vehicle for storage in the reservoir. The feedstock is delivered to the vehicle from an external source, for example a fueling station. The feedstock includes natural gas or other light hydrocarbon (e.g., less than 3, 4, or 5 C, etc.), alone or in combination. The vehicle is one of a land vehicle, an aircraft, a marine vessel, or a spacecraft. Processes of the inventive subject matter generate carbon byproduct, which is further compressed or otherwise stored in a container within the vehicle.

Systems, methods, and devices for power generation in a vehicle are further contemplated. A reformer is configured to receive feedstock as an input and generate hydrogen as an output. One or more fuel cells is coupled to the reformer and generates electricity from the hydrogen, which then operates an electric motor or device of the vehicle. A feedstock storage container in the vehicle is coupled to the reformer to supply feedstock to the reformer, for example via a feedstock inlet fluidly coupled to the feedstock storage container. The feedstock storage container typically stores the feedstock under a set pressure. Compatible vehicles include land, air, marine, or space vehicles. In some embodiments a battery is operatively coupled with the reformer and the electric motor such that the battery stores electricity received from the reformer and supplies electricity to the electric motor or other electric device of the vehicle. The electric motor is operatively coupled with and drives the drivetrain of the vehicle. A carbon storage container is also coupled to the reformer to collect and store carbon byproduct (e.g., carbon black, nanostructure carbon, etc.) generated by the reformer.

Systems, methods, and devices for distributing carbon is also contemplated. A reforming process (e.g., plasma reforming) is performed on a feedstock to generate carbon and a reform product. The carbon is separated from the unreformed feedstock and the reform product. The carbon is compressed and distributed. The reforming process typically uses one or more plasma devices, for example DBD, nonthermal, or microwave plasmas, alone or in combination. The dimensions of generated carbon (e.g., carbon black, nanostructure carbon, etc.) are controlled based on the reforming process as well as external factors such as agitation of the growing structures. Preferably at least 20% of the generated carbon is in nanostructure form. Nanostructure carbon is highly valuable and is preferably separated from the other generated carbon before the step of compressing.

Reforming, separating, and compressing the carbon is typically performed in a vehicle powered by a feedstock-based fuel cell, for example a locomotive, a tanker ship, or a spacecraft. The feedstock is typically natural gas or other light hydrocarbon, or combinations thereof. The reform product is typically H2, which is then compressed, distributed, or otherwise used as fuel for a fuel cell, for example a fuel cell powering the vehicle. In some embodiments the reforming process uses a cold plasma reformer, for example a non-thermal plasma to reform the feedstock.

Systems, methods, and devices for reducing weight in an electric vehicle (EV) with an electric motor are contemplated. A plurality of batteries installed in the EV are removed, providing a cavity. At least some components (preferably all, 90%, 80%, 70%, 60%, or most) of a feedstock powerplant are installed in the cavity, including a feedstock reservoir fluidly coupled to a feedstock intake, a reformer fluidly coupled to the feedstock reservoir, and one or more fuel cells fluidly coupled with the reformer and operatively coupled with either a battery remaining in the vehicle (if any) or the electric motor of the vehicle. A feedstock intake is typically accessible at a periphery of the EV. A carbon storage container can further be installed (either in the cavity or out) coupled with the reformer in order to store a carbon (e.g., carbon black, nanostructure carbon, etc.) output of the reformer.

Typically the removed batteries are 50% or more of the batteries originally installed in the EV, though in some cases the removed batteries are at least 90% of the original batteries. The feedstock is typically natural gas or other light hydrocarbon, and the EV is either a land, an air, marine, or a space vehicle. The feedstock reservoir max capacity is typically 50 kg, and represents at least a 50%, 100%, 150%, 200%, 250%, or 300% or more weight reduction over the removed batteries.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A depicts a system of the inventive subject matter.

FIG. 1B depicts application of a system of the inventive subject matter.

FIG. 2 depicts another application of a system of the inventive subject matter.

FIG. 3 depicts yet another application of a system of the inventive subject matter.

FIG. 4 depicts still another application of a system of the inventive subject matter.

FIG. 5 depicts a flow chart of a process of the inventive subject matter.

FIG. 6 depicts a prior art device.

FIG. 7 depicts another prior art device.

FIG. 8 depicts a flow chart of another process of the inventive subject matter.

### DETAILED DESCRIPTION

One should appreciate that the disclosed techniques provide many advantageous technical effects including simplifying clean energy production and use, as well as valuable byproducts.

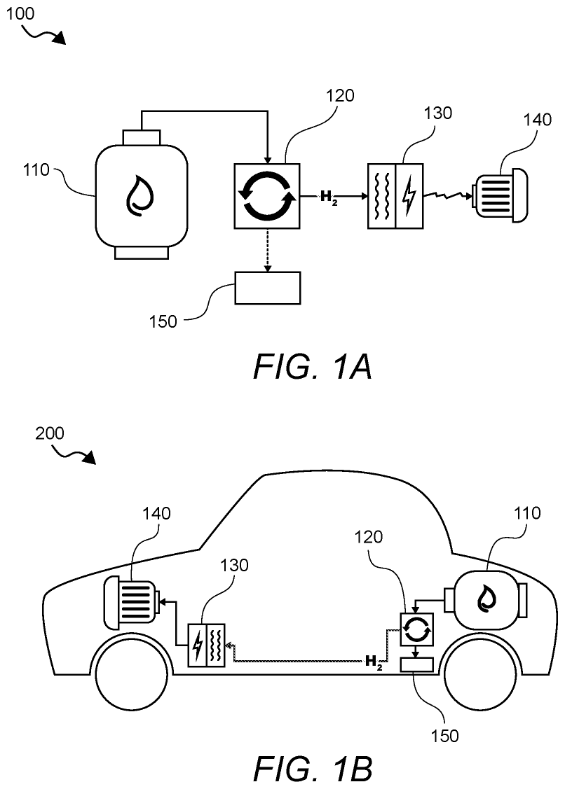

FIG. 1A shows a system 100 of the inventive subject matter in isolation. The system 100 includes a feedstock (e.g., natural gas or other light hydrocarbon, e.g. <C5) reservoir 110 that is fluidly coupled to a reformer 120. The reformer 120 is the fluidly coupled with at least one fuel cell 130, to which it supplies hydrogen. The fuel cell(s) 130 is/are electrically coupled with an electric motor 140 that provides power for propulsion and other functions of a vehicle, or other electrically powered devices. It should be appreciated that the reformer can be a cold plasma reformer. As seen in FIG. 1A, the system 100 also includes a carbon storage container 150 that is fluidly coupled with the reformer 120 to store carbon byproduct. The steps of the methods of the inventive subject matter will be discussed in further detail below.

In the discussion herein, references are made to the use of natural gas as an example of a suitable feedstock. However, it is understood that other suitable light hydrocarbons could be used.

It has now been discovered that this can be accomplished using a non-thermal plasma to reform the feed gas into substantially pure (≤5% wt/wt impurities) H2 and carbon, and feeding the H2 into fuel cells to produce the electricity.

The nomenclature for nonthermal plasma (“NTP”) found in the scientific literature is varied. In some cases, the plasma is referred to by the specific technology used to generate it (“gliding arc”, “plasma pencil”, “plasma needle”, “plasma jet”, “dielectric barrier discharge”, “Piezoelectric direct discharge plasma”, etc.), while other names are more generally descriptive, based on the characteristics of the plasma generated (“one atmosphere uniform glow discharge plasma”, “atmospheric plasma”, “ambient pressure nonthermal discharges”, “non-equilibrium atmospheric pressure plasmas”, etc.). The two features which distinguish NTP from other mature, industrially applied plasma technologies, is that they are 1) nonthermal and 2) operate at or near atmospheric pressure.

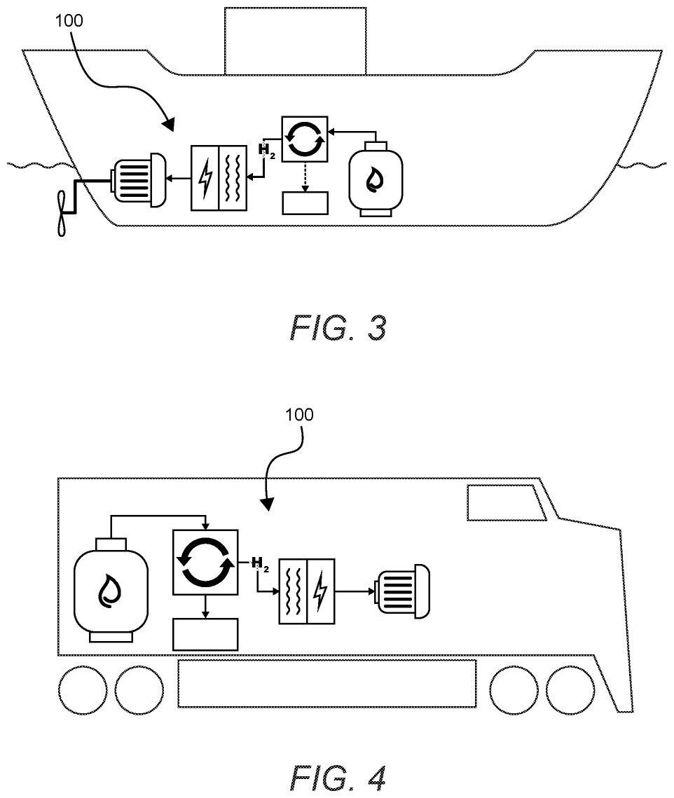

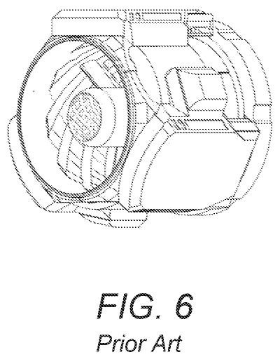

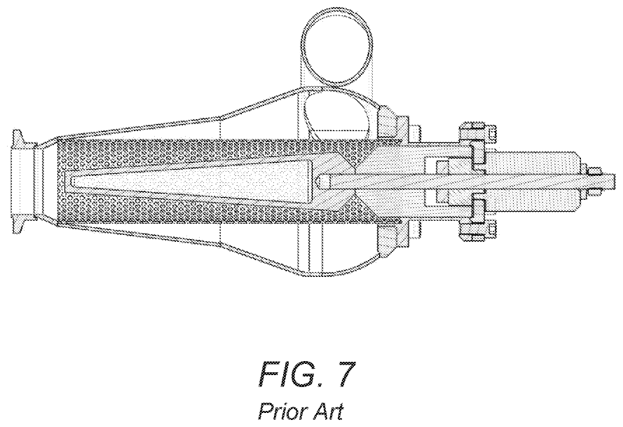

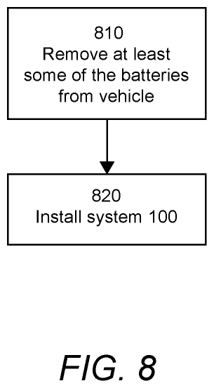

Reformer 120 used in the systems and methods of the inventive subject matter typically include cold plasma reformers that can be used in this fashion, for example those described in U.S. Pat. No. 10,293,303 to Hill or U.S. Pat. No. 10,947,933 to Hill, which are incorporated in their entirety herein by reference. While such devices are primarily taught to treat intake flows or exhaust flows to increase combustion efficiency or otherwise reduce harmful combustion emissions, surprisingly such devices are unexpectedly effective at reforming hydrocarbons to separate hydrogen from carbon and produce nearly pure H2 and carbon (e.g., carbon black) at a high rate of efficiency without pollutants. See '303 Patent at FIG. 14B or '933 Patent at FIG. 3 for examples of such devices. Such devices can be used stand-alone or arranged in a serial or parallel fashion, either linearly, recursively, or nested, etc. FIG. 14B of the '303 patent is reproduced here as FIG. 6 and FIG. 3 of the '933 patent is reproduced here as FIG. 7.

In embodiments of the inventive subject matter, the system 100 includes a filter (such a carbon separator) coupled with the output end of the reformer 120. An example of a suitable filter is a cyclone type filter, though other suitable filters are also contemplated. The filter separates the hydrogen produced by the reformer 120 from the carbon byproduct. The carbon byproduct is then directed to the carbon storage container 150.

In embodiments of the inventive subject matter, the system 100 can also include a battery that is between the fuel cell 130 and the electric motor 140 to store excess energy and/or manage energy output to the electric motor 140 (e.g., provide extra energy during acceleration). The battery can also be connected to a regenerative braking system to recover energy during deceleration.

Viewed from another perspective, feedstock 110 is fed to a reformer and separator, collectively shown as 120, to thereby produce carbon, for example carbon black. It is contemplated that the generated carbon can be sent to a compressor (e.g., part of container 150, between container 150 and reformer 120, etc.) to thereby produce compressed carbon for distribution. H2 is provided to fuel cell or other (e.g., H2 burning ICE) power generator 130 that uses the H2 as fuel to generate electricity for a motor or other electrically powered device 140. It should be appreciated that the reformer can be a cold plasma reformer.

It is contemplated that the dimensions of generated carbon are controlled based on the reforming process. Parameters that can be controlled in the reformer process to affect carbon dimensions include temperature and pressure and type of plasma (e.g., non-thermal plasma, DBD plasma, microwave plasma, etc.), as well as agitation of growing carbon structures. It should be appreciated that at least 20% of the generated carbon can be in nanostructure form. In other embodiments, at least 30%, 40%, or 50% of the generated carbon can be in nanostructure form. In embodiments where generated carbon is produced in nanostructure form, it is contemplated that nanostructure carbon can be removed from the other generated carbon before the step of compressing.

Viewed from yet another perspective, system 100 can be used to modify or retrofit an electric vehicle to replace some or all of the batteries, for example to remove weight from the vehicle or otherwise rehab an aging or failing battery system. For example, it is known that lithium ion batteries typically used in EV applications have a limited life of use do to chemical or physical failures of the battery. Thus, rather than replacing a failing battery pack with a new battery pack, users have the option to replace a portion (or all) of the battery pack with a fuel cell solution based on the reformer system of the inventive subject matter, saving costs and substantially reducing curb weight of the vehicle.

For example, in such modification or retrofit uses the dimensions and maximum capacity of reservoir 110 can be limited for available space (e.g., dimension of removed batteries) and/or weight optimization. It is contemplated that the maximum capacity of the reservoir can be 50 kg (approximately 110 pounds), a substantial weight reduction (e.g., >20%, >30%, >40%, etc.) over a comparable volume of lithium ion battery.

FIG. 1B shows the system 100 integrated into a land vehicle 200, in this case an automobile. It should be understood that the system 100 can be integrated into other land vehicle such as trucks, military vehicles, busses, tractors, etc.

In the application of FIG. 1B, the electric motor is used to power the drivetrain of the car 200 so that the car is able to move. The electric motor can also be used to power other components of the vehicle 200 such as electronics, climate control, etc.

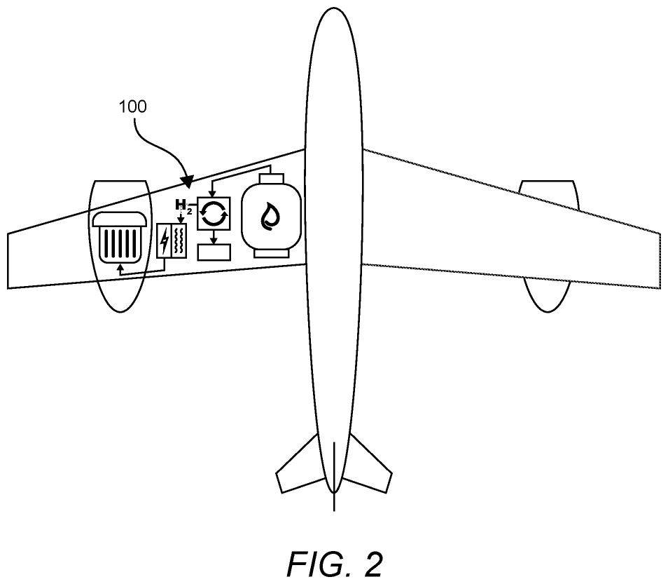

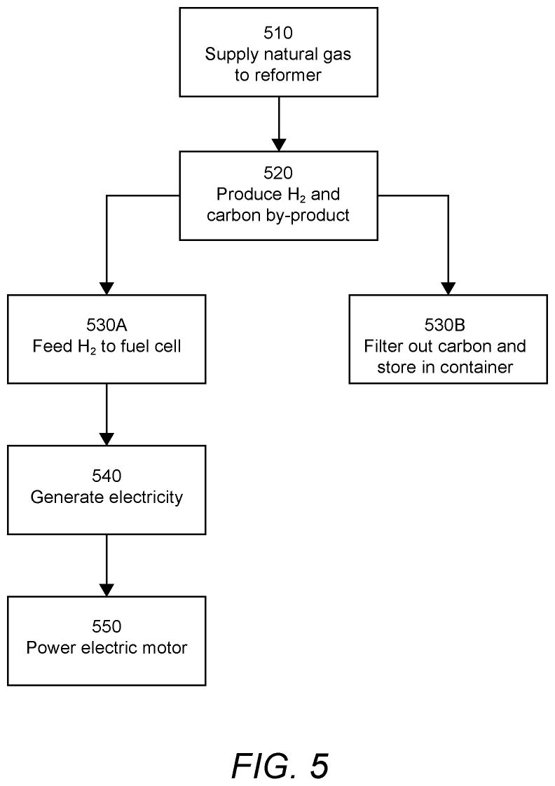

FIGS. 2-4 illustrate the incorporation of system 100 into other vehicle types, such as aircraft (FIG. 2), marine vehicles (e.g., boats and ships—FIG. 3), and trains (FIG. 4). It is further contemplated that the systems and methods of the inventive subject matter could also be applied to spacecraft or any other type of vehicle.

For each of the vehicles shown in FIGS. 1B-4, the system 100 will also include a fuel intake coupled with the reservoir 110 that allow for refilling of the reservoir 110 with natural gas. For example, for the automobile 200 of FIG. 1B, the natural gas intake could accommodate a nozzle from a natural gas refueling station that has a similar user interface as a common gasoline fueling station, thus taking advantage of a user's familiarity with traditional internal combustion engine vehicles.

In the FIGS. 1B-4, the carbon storage container 150 is intended to be accessible by a user such that as it is filled with carbon byproduct, it can be emptied for additional use.

With further respect to production of carbon (e.g., carbon black), the steps of reforming, separating, and compressing carbon from a feedstock can be performed on a vehicle at least partially powered by a feedstock-based fuel cell. Suitable vehicles include automobiles, locomotives, tanker ships, or spacecraft. For example, FIG. 1B shows an automobile 200 having components (110, 120, 130, 140, 150) to perform steps of reforming, separating, and compressing. It should be appreciated that automobile 200 is at least be partially powered by a feedstock-based fuel cell. Furthermore, FIGS. 2-4 show an aircraft, a tanker ship, and a locomotive, respectively, that each include systems 100 for reforming, separating, and compressing as described above, and such systems allow the aircraft, the tanker ship, and the locomotive to at least be partially powered by a feedstock-based fuel cell.

Benefits specific to long haul operations (e.g., locomotive, tanker ship, spacecraft, etc.) and expeditionary operations (e.g., automobile, marine craft, spacecraft, etc.) should be appreciated. For example, a long haul transport application of the inventive reformer system offers multiple improvements over the art. First, the where the cargo to be hauled is natural gas (e.g., CNG, LNG, etc.), an onboard reformer (or reformers) could be used with a fuel cell (or H2 burning ICE) to power propulsion of the vehicle. Thus, a train or ship hauling natural gas could use the onboard gas to propel the vehicle to its destination. Next, such a long haul operation propelled by onboard natural gas in the described manner will also arrive with a substantial weight of valuable carbon black or carbon nanostructure material, depending on the length or time of transport. Thus, not only does such transport improve efficiency by requiring a single loaded cargo, natural gas for both cargo and fuel, but it further generates a valuable secondary material during transit while also eliminating emission of carbon gases.

With respect to expeditionary operations, an exploring vessel likewise uses H2 generated from natural gas by a reformer system to propel the vessel. The prime benefit here is that upon arrival at a destination or waypoint, or as needed throughout the journey, the vessel generates and can use carbon black and other carbon nanostructures as a raw material for construction or repair, for example by way of a 3D or material printer.

Regarding retrofitting or modifying EVs, system 100 can be integrated into a land vehicle, for example 200 of FIG. 1B, replacing part or all of the traditional battery system , in this case an automobile. It should be understood that the system 100 can be integrated into other land EVs such as trucks, military vehicles, busses, tractors, etc. Likewise, vehicles of FIGS. 2-4 can be retrofitted or modified to replace batteries with system 100 as described above.

FIG. 5 is a flowchart illustrating the processes of the inventive subject matter.

At step 510, the reservoir 110 supplies natural gas to the reformer 120. The reformer 120 generates hydrogen from the natural gas at step 520, with carbon as a byproduct.

At step 520, the reformer 120 produces hydrogen and a carbon byproduct from the natural gas. The produced hydrogen is fed to the fuel cell(s) at step 530A and the carbon is filtered out and stored in the container 150 at step 530B.

At step 540, the fuel cells generate electricity from the hydrogen and supply the electricity to power the electric motor 140 at step 550. As discussed above, embodiments of the inventive subject matter may include a battery in the system 100. In these embodiments, step 550 can include supplying electricity to the battery, which in turn stores it and/or supplies it as needed to the electric motor 140.

In embodiments of the inventive subject matter, the natural gas must be pressurized so as to be supplied at the appropriate pressure to the reformer 120 and/or to reduce the size of the reservoir 110 required in the vehicle. In these embodiments, the pressurization can be performed by the reservoir 110 as it is being filled by using a pump or other mechanism, or the natural gas can be fed into the reservoir already at pressure from an external source such as an external pump.

FIG. 8 is a flowchart illustrating a process of the inventive subject matter.

At step 810, at least some of the existing batteries of an electric vehicle (e.g., where 200 is an EV) are removed. In some embodiments, at least 50% of the batteries are removed. In other embodiments, at least 90% of the batteries are removed. In still other embodiments, all of the batteries are removed. It should be appreciated that, compared to EVs, FCEV use substantially less or smaller batteries. For example, where an EV may use 50 Kwh, 60 Kwh, 70 Kwh, or more than 100 Kwh of battery storage to achieve ranges of 150 or more miles, a comparable FCEV requires a battery of less than 10 Kwh, 5 Kwh, or 3 Kwh to propel the same vehicle, with substantial reduction of curb weight and thus improved fuel efficiency.

At step 520, the system 100 is installed. In embodiments where all of the existing batteries are removed from the vehicle 200 and a battery is used in the system 100, the system 100 will include its own battery. In embodiments where some of the existing batteries are left in the vehicle 200, the system 100 can integrate the remaining batteries for its own functions.

Additional modifications to the vehicle can include installing a fuel intake that allows for the filling of the reservoir 110 from an external source.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of powering a vehicle from natural gas, comprising:
supplying a feedstock to a reformer within the vehicle;
producing, by the reformer, hydrogen from the feedstock;
generating, by a fuel cell, electricity from the hydrogen; and
using the generated electricity to power an electric motor.

2. The method of claim 1, further comprising, after the step of generating electricity:
storing the electricity in a battery; and
wherein the step of using the generated electricity to power an electric motor further comprises:
supplying stored electricity from the battery to the electric motor and powering the electric motor with the supplied electricity.

3. The method of claim 1, further comprising storing the feedstock in a feedstock reservoir within the vehicle.

4. The method of claim 1, further comprising introducing the feedstock into the vehicle from an external source.

5. The method of claim 1, wherein the feedstock comprises natural gas or other light hydrocarbon.

6. The method of claim 1, further comprising pressurizing the feedstock prior to the step of supplying.

7. The method of claim 1, wherein the vehicle comprises a land vehicle, an aircraft, a marine vessel, or a spacecraft.

8. The method of claim 1, further comprising storing, in a container within the vehicle, a carbon byproduct generated by the reformer.

9. A power generation system in a vehicle, comprising:
a reformer configured to receive feedstock as an input and generate hydrogen as an output;
at least one fuel cell operatively connected to the reformer, the at least one fuel cell configured to generate electricity from the hydrogen; and
an electric motor operatively connected to the fuel cell.

10. The system of claim 9, further comprising a feedstock storage container fluidly coupled to the reformer such that feedstock stored in the storage container is supplied into the reformer.

11. The system of claim 10, further comprising a feedstock inlet fluidly coupled to the feedstock storage container.

12. The system of claim 10, wherein the feedstock storage container is configured to store the feedstock at a predetermined pressure.

13. The system of claim 9, wherein the vehicle comprises a land vehicle, an aircraft, a marine vessel, or a spacecraft.

14. The system of claim 9, further comprising a battery operatively coupled with the reformer and the electric motor, the battery configured to store electricity received from the reformer and supply electricity to the electric motor.

15. The system of claim 9, wherein the electric motor is operatively coupled with the drivetrain of the vehicle.

16. The system of claim 9, wherein the feedstock comprises natural gas or other hydrocarbon.

17. The system of claim 9, further comprising a carbon storage container coupled to the reformer, the carbon storage container configured to store a carbon byproduct generated by the reformer.
